(19) United States
(12) Patent Application Publication
(10) Pub. No.: US 2012/0061934 A1
(43) Pub. Date: Mar. 15, 2012

(54) Anti-roll vehicle suspension

(76) Inventor: Onofrio Scaduto, Stylida (GR)

(21) Appl. No.: 13/199,871

(22) Filed: Sep. 12, 2011

Related U.S. Application Data
(60) Provisional application No. 61/403,117, filed on Sep. 11, 2010.

(51) Int. Cl. B60G 21/055

(52) U.S. Cl. 280/124.106

(57) ABSTRACT

An anti-roll suspension system for a vehicle chassis having at least two laterally spaced front wheels, the suspension comprising an axle assembly for mounting each of a pair of laterally spaced wheels; a torsion bar spring assembly for mounting the chassis on each of the interconnected axle assemblies; a moveable arm connected between the spring and the chassis, and an anti roll pivoting link and connector link connected between said chassis and the moveable arm of the axles of the suspension system being responsive to a lateral force on said chassis, and structured to translate lateral force on the chassis to a vertical force on the down force side of the chassis so that the anti roll linkage simultaneously lift the down force side of the vehicle and lower the up force side of the vehicle.

### CROSS-REFERENCE TO RELATED APPLICATIONS

This application claims the benefit of provisional patent application Ser. No. 61/403,117, filed 2010 Sep. 11 by the present inventor.

### BACKGROUND

1. Prior Art

The following is a tabulation of some prior art that presently appears relevant:

U.S. Patents

| Patent Number | Kind Code | Issue Date | Patentee |
|---|---|---|---|
| 2,152,938 | — | 1939 Apr. 04 | Welch |
| 2,787,473 | — | 1957 Apr. 02 | Chiodo |
| 6,722,676 | B2 | 2004 Apr. 20 | Zadok |
| 6,793,228 | B2 | 2004 Sep. 21 | Zadok |

2. Field of the Invention

The present invention relates generally to automotive vehicle suspension systems, and pertains more particularly to a vehicle suspension system that is responsive to the inertial forces on the vehicle chassis to counteract and limit vehicle body roll.

3. Discussion of the Related Art

Generally vehicles have a body or chassis typically with an enclosed operator and passenger compartment with the body being resiliently supported by a suspension system on wheel assemblies that carry it over generally horizontal road and street surfaces.

A vehicle may be driven through the rear wheels, the front wheels or both. It typically has steerable front wheels and non-steerable rear wheels. The typical suspension system normally employs springs to support the body on the wheel assemblies, and with damping means in the form of hydraulic cylinders that act to dampen oscillations and movements of the body relative to the wheel assemblies and to reduce the transmission of shock from the wheels to the body.

The construction of the suspension system is often a compromise between a soft suspension for providing a soft comfortable ride for passengers over rough roads and a stiff suspension, which enhances the safety and stability of the vehicle, but is often uncomfortable for passengers. A stiffer suspension transfers more shock of the suspension to the chassis and offers less comfort to passengers but increases the stability of the vehicle.

When the typical vehicle enters a turn the resulting centrifugal forces acting on the vehicle tend to roll the vehicle body about its roll center relative to the underlying suspension system. This centrifugal force also tends to displace the body laterally outwardly tending to cause the vehicle to pivot about the contact of its outer wheels with the road surface.

The construction of a vehicle body and the configuration of the vehicle suspension systems determine the location of the roll center. In a conventional vehicle, the roll center of the vehicle is typically below the center of mass or gravity of the vehicle. Centrifugal forces tending to roll the vehicle body act on a lever arm or through a lever arm determined by the vertical distance between the center of gravity and the roll center. This is known as the roll couple.

As a vehicle body moves through a turn the body tends to roll and shift the weight onto the outer wheels and springs while simultaneously unloading the inner suspension springs thereby reducing the cornering traction of the vehicle. The body also tilts or rolls toward the outside of the curve shifting the center of mass of the vehicle toward the outside of the curve. This rolling of the body about its roll center when negotiating a turn is often discomforting to operator and passengers. Stiffer suspensions which tend to reduce this tendency to roll also subjects the passengers and operator to the jolting and jarring of rough roads.

A number of approaches to overcoming this tendency of the vehicle to roll during cornering have been proposed in the past. One approach has been to provide the vehicle with anti-sway bars in the form of torsion bars between the two sides of the suspension. While this approach helps reduce roll, it is not satisfactory.

Another approach has been to provide the vehicle with linkage system powered by electric motors to selectively tilt the inwardly during cornering. Such a system is disclosed in U.S. Pat. No. 2,152,938. This system is also unsatisfactory for several reasons. Other attempts at solving the cornering problems have provided for the wheels of the vehicle to tilt into a curve. These have been powered by various means such as electrical and hydraulic systems. One such system that is powered or controlled by the steering of the vehicle is disclosed in U.S. Pat. No. 2,787,473. These systems are generally complicated and expensive.

The suspensions of U.S. Pat. No. 6,722,676 and U.S. Pat. No. 6,793,228 comprises an axle assembly for mounting each of a pair of laterally spaced wheels, a spring assembly supporting the chassis on each of the axle assemblies, a moveable arm connected between the spring and the chassis, and an anti-roll linkage connected between the chassis and the moveable arm of the axles of the suspension system being responsive to a lateral force on the chassis, and structured to translate lateral force on the chassis to a vertical force on the down force side of the chassis so that the anti-roll linkage simultaneously lifts the down force side of the vehicle and lowers the up force side of the vehicle.

Others have attempted to overcome this problem by designing the suspension system so that the roll center of the vehicle is disposed above its center of its gravity. Most of these systems are complicated and expensive. These systems also have other serious drawbacks.

Accordingly there is a need for a simple anti-roll suspension system that overcomes the above problems of the prior art.

### SUMMARY OF THE INVENTION

I have devised the present system to be less complicated and more space efficient than those and particularly applied to a torsion bar suspensions, but variants are possible using other types of springs. Conventional torsion bar-type suspensions have been employed as part of a wheel suspension for use in vehicles. The torsion bar-type suspension typically includes an arm mechanism and a torsion bar spring, generally referred to as a torsion bar. The arm mechanism supports a wheel and is vertically rotatable coupled to a vehicle body. The suspension can be utilized in a fixed wheel assembly or in a steerable wheel assembly. The torsion bar is securely interposed between the arm mechanism and the vehicle body and undergoes torsional deformation in response to vertical rotation of the arm mechanism. When a force acts on a wheel in a top to bottom direction with respect to the vehicle body, the arm mechanism vertically rotates. Since the torsion bar undergoes torsional deformation in response to the rotation of the arm mechanism, the top to bottom force acting on the wheel is transferred to the torsion bar which acts as a spring. Typically, the end of the torsion bar that is fixed to the vehicle body is provided with splines or a hexhead that engage corresponding grooves in an anchor rigidly coupled to the vehicle body.

The present invention solves the problem of excessive vehicle body roll and also reverses it if desired. Broadly, the present invention provides a suspension system having a linkage that translates lateral body movement into a lift force on the down load side of the body. More specifically, one embodiment of the invention comprises an anti-roll suspension for a vehicle chassis having at least two laterally spaced wheels, wherein the suspension comprises an axle assembly for rotatably mounting each of a pair of laterally spaced wheels, a torsion bar spring assembly supporting the chassis on each of the axle assemblies, and anti-roll linkage comprising a lower moveable control arm that connects its inner end to the vehicle chassis or body and connects its outer end to the top of a pivoting link in a generally longitudinal pivoting manner. The axle assembly connects to the pivoting link below said pivot line where the rotation of the axle assembly occurs for a front suspension application. Below the pivot line of the lower moveable control arm the pivot link connects to a lower connecting link that connects its inner end to a bellcrank that is rigidly connected to the front of a torsion bar sleeve tube.

Said sleeve tube is rigidly connected at its back end to a torsion bar anchor that houses the back end of the torsion bar spring that lies within the sleeve tube in a hidden view. Said bellcrank along with said tube sleeve and said torsion bar anchor perform in a rotatable manner as one rigid suspension component that is connected to the inner sleeve of a free rotating bearing or sleeve. Said bearing or sleeve is housed in a bracket coupled to the chassis or body. The longitudinal torsion bar anchor assembly connects laterally to the other side through a bracket that rigidly mounts one end to the torsion bar anchor assembly and connects the other end to a pivoting tie link or bar that will permit adjustment of the Vehicle Ride Height. The front end of the torsion bar is secured to the lower moveable control arm; the inner sleeve of a bearing connects to the rear of said arm and the outer bearing sleeve fits inside the torsion bar tube sleeve.

Additionally, the torsion bar anchor connects the front and rear longitudinal wheel suspension, which generally mirrors the front suspension layout. Said anti-roll linkage system is structured and configured to translate a lateral force on the chassis to a lateral counter movement of said chassis to the up force side (inside of the turn) of the suspension and a vertical upward movement of the down force side (outside of the turn) of the chassis so that the anti-roll linkage simultaneously shifts the chassis laterally to the up force side of the wheels, lifts the down force side of the chassis and lowers the up force side of the chassis to thereby counteract roll of the chassis.

### BRIEF DESCRIPTION OF THE DRAWINGS

The nature, goals, and advantages of the invention will become more apparent to those skilled in the art after considering the following detailed description when read in connection with the accompanying drawing, illustrating by way of examples the principles of the invention, in which like reference numerals identify like elements throughout wherein:

FIG. 1 illustrates a perspective, partial view of a vehicle support structure having front and rear wheel assemblies coupled to such support structure, as viewed from above the vehicle support structure.

FIG. 2 is a front elevation view of a vehicle showing the front of one exemplary embodiment of the invention with the vehicle body in a static condition;

FIG. 3 is a front elevation view of a vehicle showing the front of one exemplary embodiment of the invention with the wheel assemblies in bump and rebound conditions;

FIG. 4 is a front elevation view of a vehicle showing the front of one exemplary embodiment of the invention with the vehicle in a severe right turn;

FIG. 5 is a rear elevation view of a vehicle showing the rear suspension of one exemplary embodiment of the invention with the vehicle in a severe left turn;

FIG. 6 is a partial perspective view of a wheel assembly;

FIG. 7 is a partial part-sectional perspective view of a wheel assembly;

FIG. 8 is a partial cross-sectional view of the front torsion bar coupling to the lower moveable control arm;

FIG. 9 is a partial, part-sectional, cross-sectional, exploded perspective view of a wheel assembly;

FIG. 10 is a sectional view of the torsion bar anchor and connector between front and rear suspensions for a vehicle with a long wheelbase;

FIG. 11 is a sectional view of the torsion bar anchor and connector between front and rear suspensions for a vehicle with a short wheelbase;

FIG. 12 is a sectional view of the torsion bar anchor for a vehicle with a single axle requirement;

FIG. 13 is a top view of an exemplary embodiment,

FIG. 14 is a side view of an exemplary embodiment,

FIG. 15 is a view like FIG. 5, showing the condition of the rear suspension with the vehicle in a turn.

It will be recognized that some or all of the Figures are schematic representations for purposes of illustration and do not necessarily depict the actual relative sizes or locations of the elements shown.

### DRAWINGS—REFERENCE NUMERALS

20 front suspension
22 chassis or body
24 wheel
26 axle assembly
28 control arm
30 torsion bar
32 front and rear torsion bar connector—long wheelbase
34 front and rear torsion bar connector—short wheelbase
36 torsion bar anchor
38 torsion bar anchor and connectors' bearing
40 chassis brackets for bearing
42 torsion bar sleeve tube
46 torsion bar sleeve tube outer bearing
50 torsion bar sleeve tube outer damper bracket
52 connecting link
54 pivoting link
56 pivoting link connector
58 washer
60 locknut
64 damper
70 torsion bar sleeve tube lateral connecting bracket
72 lateral connecting link
80 rear suspension

### DETAILED DESCRIPTION OF THE PREFERRED EMBODIMENTS

In the following paragraphs, the present invention will be described in detail by way of example with reference to the attached drawings. In the description, the parts and components of the present invention, which are the same, will be referred to by the same or similar reference symbols. Unless defined otherwise, all technical and scientific terms used herein have the same meaning as is commonly understood by one of skill in the art to which this invention belongs. In event the definition in this section is not consistent with definitions elsewhere, the definitions set forth in this section will control. Throughout this description, the preferred embodiment and examples shown should be considered as exemplars, rather than as limitations on the present invention.

As shown in the drawing for purposes of illustration, a suspension system according to the invention responds to a lateral force on the vehicle chassis such as in a turn to shift the chassis laterally to the up force side of the wheels and provides a rapid loading of the down load side springs to reduce or eliminate or reverse roll of the vehicle body. A suspension system according to the invention provides a more comfortable ride for operator and passengers by reducing or eliminating or reversing roll of the body as the vehicle negotiates turns. The suspension system of this invention is also simple, compact and easily fabricated and installed with little or no alteration in existing vehicle design.

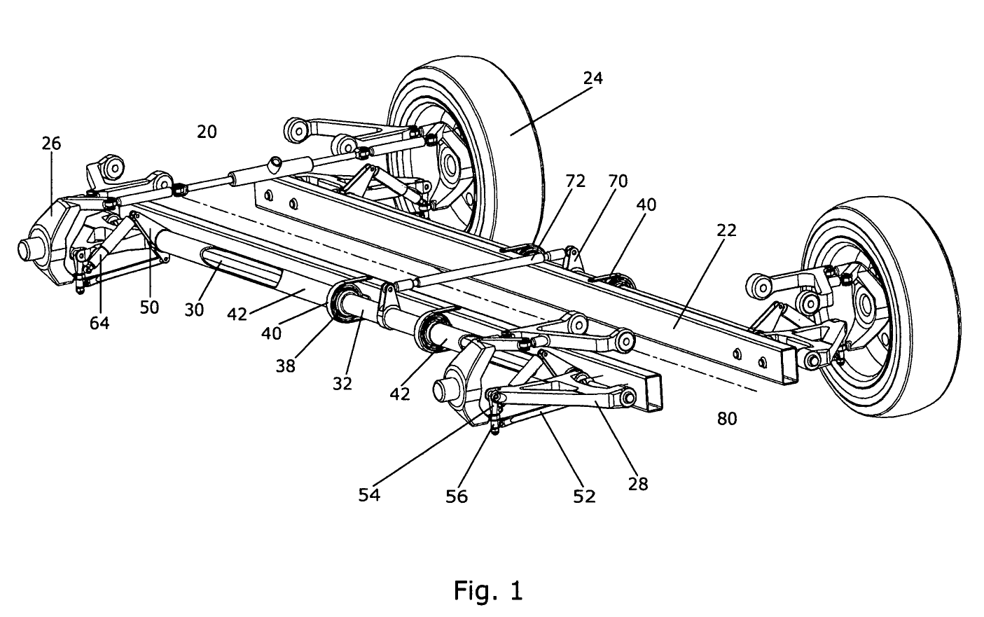

Referring to FIG. 1 and FIGS. 13-15, an anti-roll suspension system in accordance with one embodiment of the invention for a front suspension designated generally by the numeral 20 and rear suspension 80 of a vehicle chassis is illustrated. The suspension system is of the independent double arm type system incorporating the principles of the present invention. In the independent type system, each wheel is independently connected or attached to the chassis of the vehicle. The opposite sides of the vehicle chassis are supported on identical suspensions with all components identified by the same reference numerals. The suspension system is shown supporting the front and rear of a typical automotive vehicle with the vehicle chassis or body 22. The present anti-roll suspension system is devised for a vehicle chassis having two laterally spaced independently sprung steerable front wheels and non-steerable rear wheels. The front wheels may be driven, even though the drive is not shown herein.

The front suspension system 20 comprises an axle assembly 26 for independently and rotatably mounting each of a pair of laterally spaced wheels 24. The vehicle chassis 22 is supported on each of the axle assemblies by a hidden torsion bar 30. Each axle assembly is attached to the chassis by an upper control arm and a lower pivoting link 54 pivoting longitudinally at its top to a lower moveable control arm 28 which guide and allow the axle to move up and down relative to the chassis. Upper control arm and lower control arm 28 are pivotally attached at their inner end to the chassis 22. Pivoting link 54 links its lower pivoting link connector 56 to the outer end of a connecting link 52 that links its inner end to the lower end of a bellcrank 50 that is rigidly connected at its center on the outside of the front end of a torsion bar sleeve tube 42. Small hydraulic damping cylinder assembly 64 links its lower outer end to pivoting link 54 and its top inner end to the top of bellcrank 50.

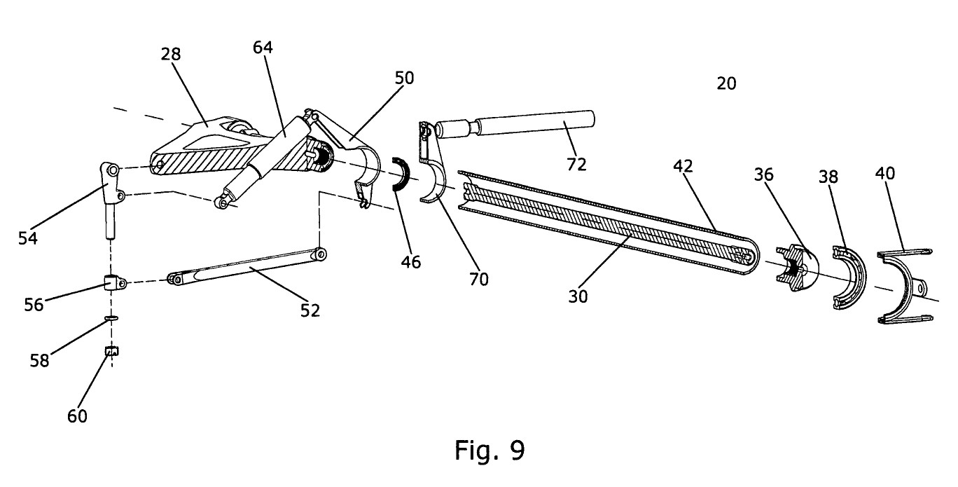

In a front suspension 20 a torsion bar 30 is coupled to the inner rear end of the lower control arm 28. In a rear suspension 80 the torsion bar 30 is secured to the front inner end of the lower control arm 28. A bearing 46 in front suspension 20 shown in FIGS. 7-9 wraps its inner sleeve around the inner rear end of lower control arm 28, the outer sleeve of bearing 46 fits inside the inner diameter of the torsion bar sleeve tube 42. This arrangement keeps the torsion bar 30 and the torsion bar sleeve tube 42 to rotate independent of each other and to keep them properly aligned with respect to each other.

Both front and rear torsion bars 30 are secured to a common torsion bar anchor 32 for vehicles with long wheelbases. Both front and rear torsion bar sleeve tubes 42 are rigidly secured at the outer section of a common generally centrally located torsion bar anchor 32. Two bearings 38 are secured on the outside of opposite ends of the torsion bar anchor 32, the bearings 38 are fitted in brackets 40 coupled to chassis 22. A lateral connector bracket 70 is rigidly secured at its lower end around the outside diameter of torsion bar anchor 32, a connecting link 72 is pivotally linked at its ends to right and left brackets 70. On the left side of a chassis 22, bellcranks 50 along with torsion bar sleeve tubes 42 and a torsion bar anchor 32 are components of a single suspension part, which we refer it as a torsion bar anchor arm.

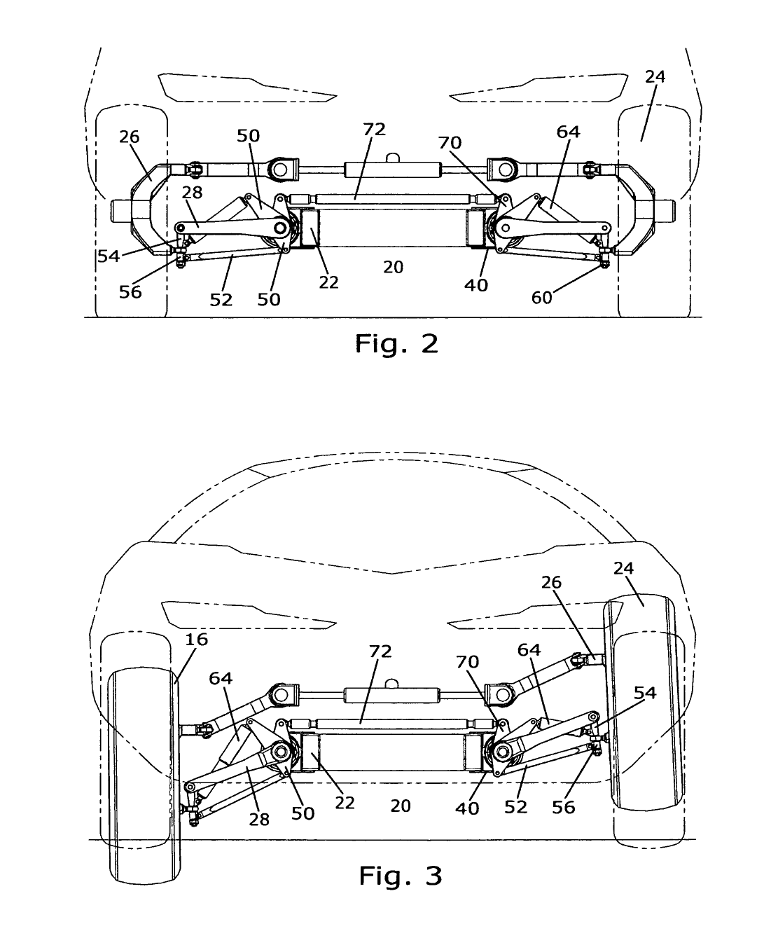

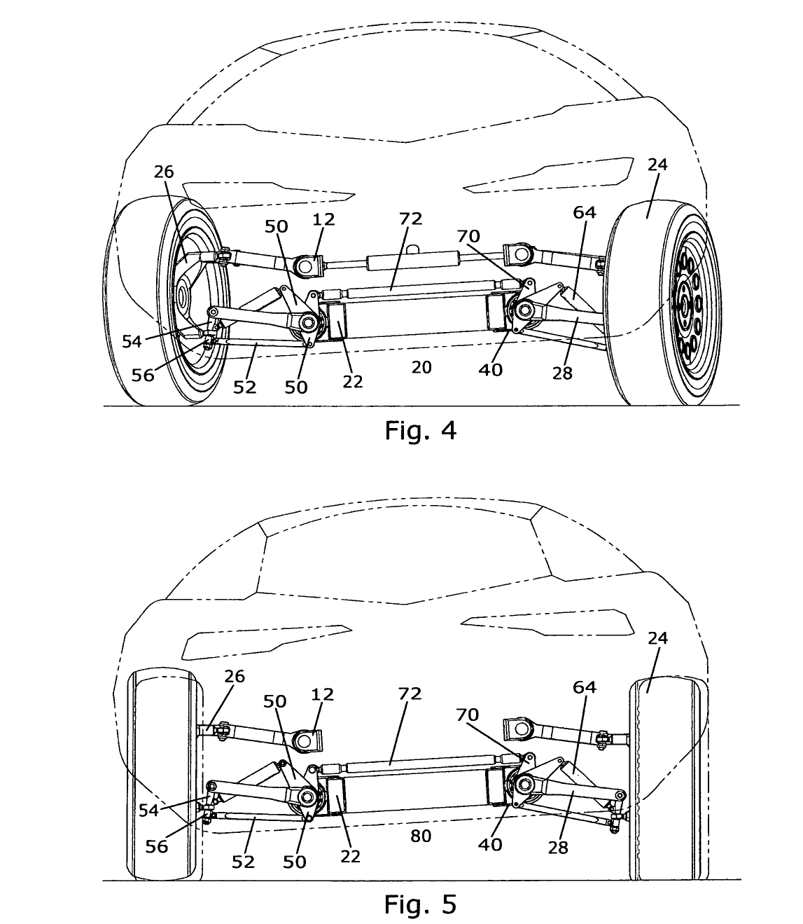

Referring to FIG. 2, it is illustrated a frontal elevation view of a vehicle 22 with front suspension 20 in a static position and in FIG. 3 the wheel assemblies 26 are in a condition of bump on the left and of rebound in the opposite side. When a force acts on a tire 24 in a top to bottom direction with respect to the vehicle body 22, the arm mechanism 28 vertically rotates.

The connecting link 52 pivots its outer end to a lower pivoting link connector 56 and its inner end to the lower end of bellcrank 50, the damper 64 connected to the top of bellcrank 50 is compressed when the tire 24 is in bump condition and extended when in rebound condition. In this exemplar embodiment the tire 24 changes to a slight negative camber, which is desirable for good handling when in bump condition.

One of the factors that affects road handling and performance is tire grip or adhesion of the tires to the road surface. An important factor that affects tire grip is camber, which is the angle the tire makes with the vertical. Positive angle tilts the top of the wheel out, and negative camber tilts the top of the wheel in. Camber angle is critical to tire traction and to vehicle handling and performance. The camber angle is controlled by the suspension linkage and its geometry. It is desirable to keep the camber angle at zero or near zero at all times to optimize road handling and performance.

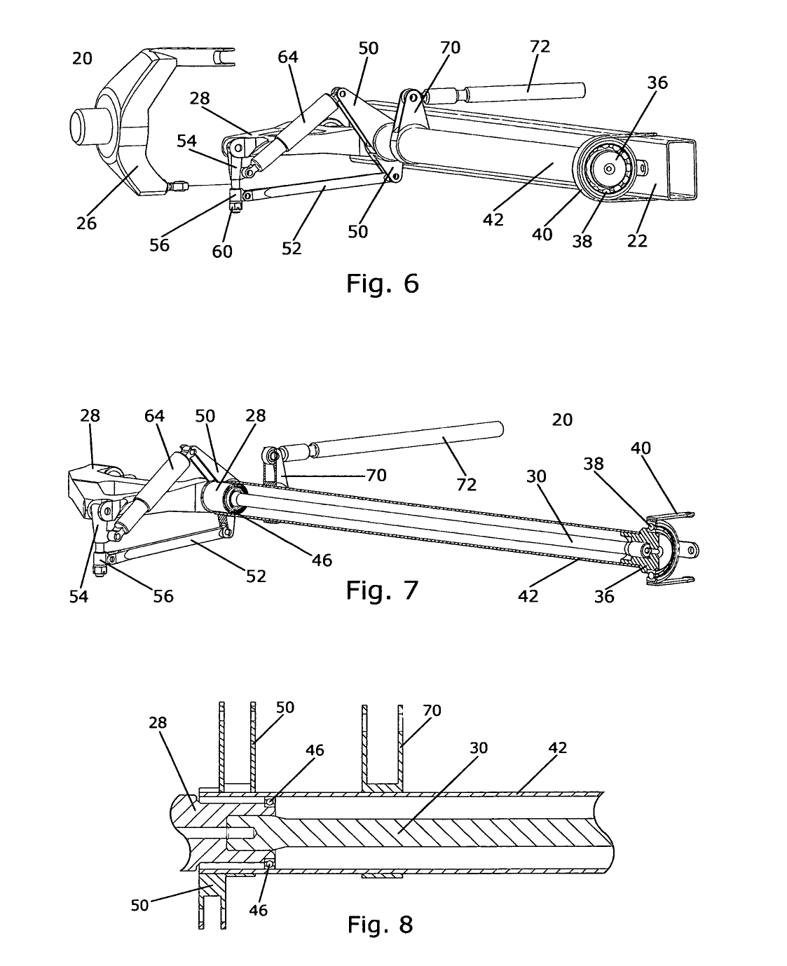

FIGS. 6-9 illustrate details of the left part of a front suspension 20 for its application to a single axle as could be used on a three-wheeler. However, the components are applicable to a wide variety of suspension requirements. A wheel axle 26 links its lower ball joint to the mid-section of a pivoting link 54, which at its top pivots in a longitudinal manner to the outer end of a lower control arm 28 whose other inner end pivots to chassis 22. This arrangement allows the wheel assembly 26 to rotate around the mid or lower point of the pivoting link 54, which operates in a vertical manner when in bump or rebound. However, centrifugal side forces will cause said pivoting link 54 to rotate around its upper pivot axis linked to the outer end of the lower control arm 28.

The lower pivoting link connector 56 is shown separately from the pivoting link 54, but it can be part of the pivoting link 54 if the wheel assembly 26 ball joint is placed lower. A connecting link 52 pivots its outer end to a lower pivoting link connector 56 and its inner end to the lower end of bellcrank 50, the connecting link 52 will rotate about its inner pivot axis when under bump and rebound conditions; centrifugal side forces will cause bellcrank 50 to rotate along the torsion bar anchor 36 longitudinal axis. The parts that will simultaneously rotate around the torsion bar anchor 36 longitudinal axis are: the bellcrank 50, torsion bar sleeve 42, lateral connector bracket 70, torsion bar anchor 36 and torsion bar 30.

In this embodiment the lateral connector bracket 70 is rigidly secured at its lower end around the outside diameter of a torsion bar sleeve 42, a connecting link 72 is pivotally linked at the top end of the lateral connector bracket 70. A bellcrank 50 along with a torsion bar sleeve tube 42, a lateral connector bracket 70 and a torsion bar anchor 36 are components of a single suspension part, which we refer it as a torsion bar anchor arm. When lateral centrifugal force is present, one side of the chassis suspension assemblies will rotate in the opposite way as the other. The torsion bar 30 will undergo torsional deformation in response to lateral centrifugal forces, its control arm 28 will consequently rotate and will push down or up on the top axis of the pivoting link 54 and push down or up on the axle assembly 26 and lastly back to ground.

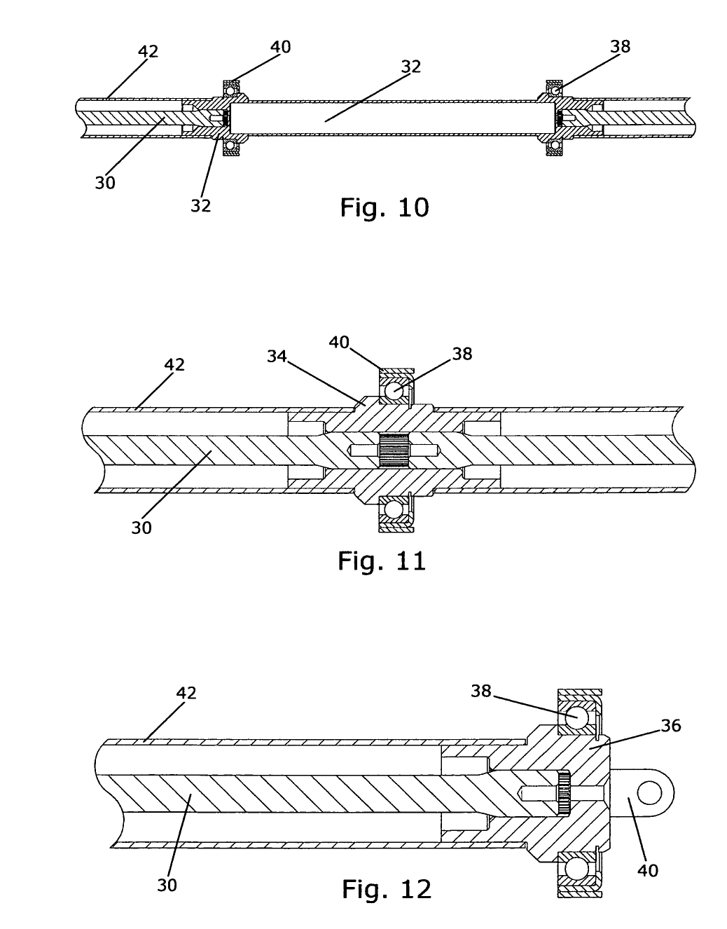

FIG. 10 illustrates a sectional view of the torsion bar anchor and connector 32 between front and rear suspensions for a vehicle with a long wheelbase, which is the length of a motor vehicle between the centers of the front and rear wheels. Front and rear torsion bars 30 and front and rear torsion bars sleeve tubes 42 connect to opposite ends of the torsion bar anchor and connector 32. The inner sleeves of bearings 38 are secured around the outer diameter of the torsion bar anchor 32, the outer sleeves of the bearings 38 are secured inside brackets 40 which are then mounted to chassis 22. Torsion bars are chosen for their thickness, length and torsional specifications; the length of a torsion bar anchor and connector 32 will be dependent on the specific wheelbase dimension requirement for a vehicle.

FIG. 11 illustrates a sectional view of the torsion bar anchor and connector 34 between front and rear suspensions for a vehicle with a shorter wheelbase. Front and rear torsion bars 30 and front and rear torsion bars sleeve tubes 42 connect to opposite ends of the torsion bar anchor and connector 34. The inner sleeve of a bearing 38 is secured around the outer diameter of the torsion bar anchor 34; the outer sleeve of a bearing 38 is secured inside a bracket 40 which is then coupled to a chassis 22. The torsion bar anchor and connector 34 will be desirable when a short wheelbase dimension is specified for a vehicle.

FIG. 12 illustrates a sectional view of the torsion bar anchor 36. A torsion bar 30 and a torsion bars sleeve tube 42 are connected to a torsion bar anchor 36. The inner sleeve of a bearing 38 is secured around the outer diameter of the torsion bar anchor 36; the outer sleeve of a bearing 38 is secured inside a bracket 40 which is then coupled to a chassis 22.

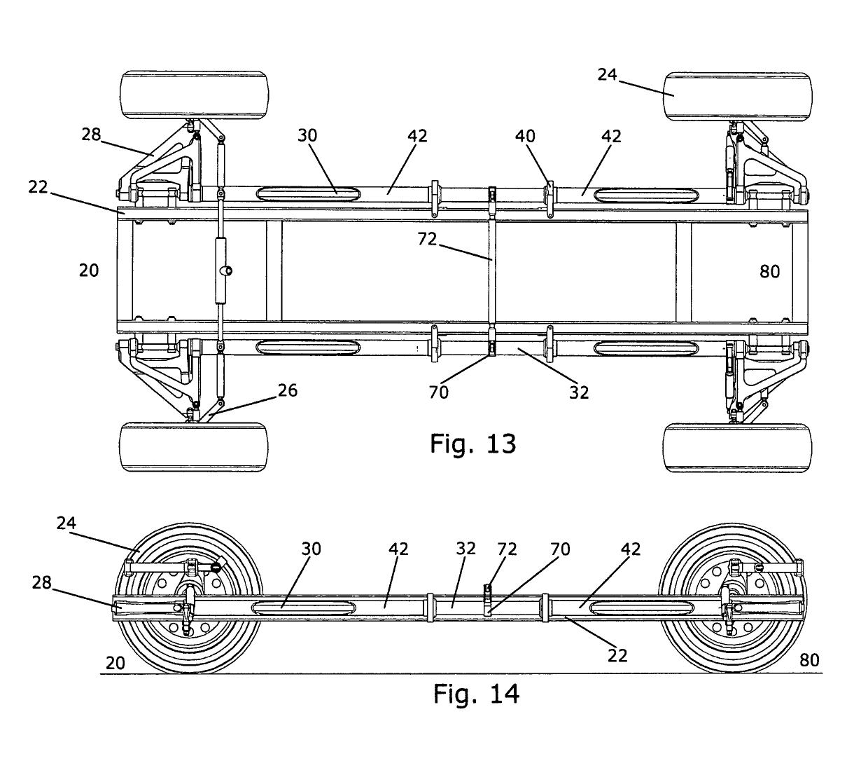

FIG. 13 is a top view of an exemplary embodiment and FIG. 14 is a side view of the same embodiment. Both views illustrate a chassis 22 and the layout of the front suspension 20 and the rear suspension 80. They demonstrate how compact the anti-roll suspension is and how it is neatly arranged around the chassis 22.

FIG. 5 illustrates a rear elevation view of the rear suspension 80 of vehicle 22 is in a severe left turn, in this exemplar embodiment the resulting inward lean of the vehicle 22 is approximately 3.3 degrees. The loaded right wheel is kept at about 0 degrees. This anti-roll suspension works conventionally with up and down forces but is reactive with lateral centrifugal forces. It simply raises the vehicle on the loaded side and lowers it on the other side. The rotational ratios of the various brackets and linkages are many and a suspension designer will have the flexibility to choose the amount of body lean desired. However, body lean is also dependant on the speed with which a vehicle is driven; a faster turn will slightly diminish body lean.

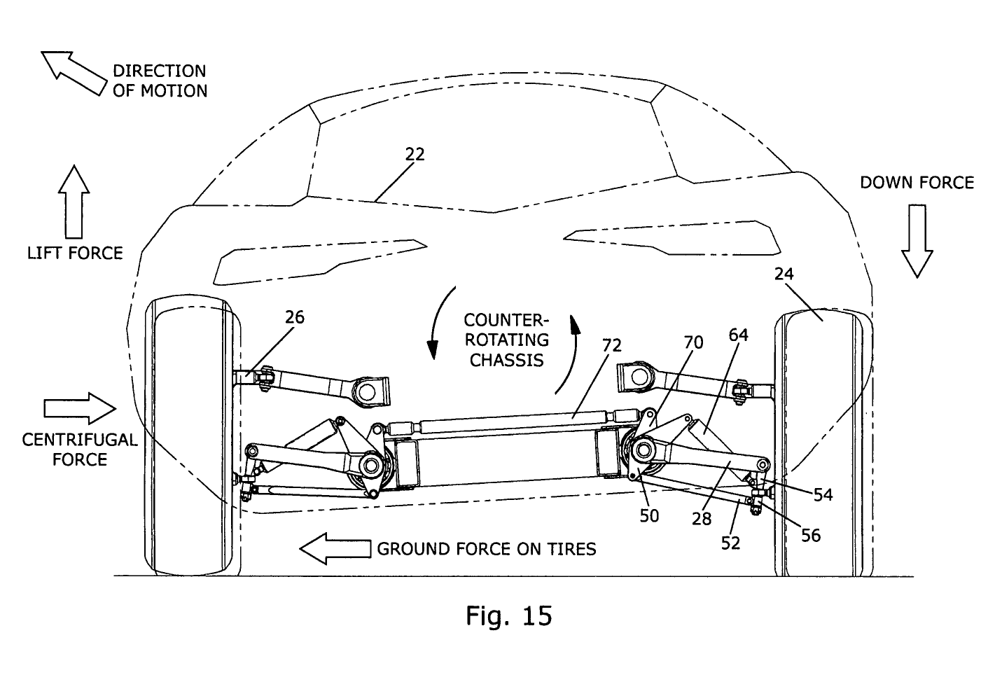

As shown in FIG. 15 the action of the suspension system of the present invention in a turn is illustrated and functions as in prior embodiments. The vehicle 22, shown in a left turn, remains substantially level at high speed and leans in at slower speed in turns as the suspension system functions through the compensating linkage to maintain the vehicle chassis level as the vehicle passes through a turn. As shown the rear of a vehicle in a severe left turn is illustrated with the chassis shifted to the right relative to the axle and wheels of the vehicle. This movement of the vehicle chassis actuates the linkage with the movement of the chassis translated by the linkage to action on the torsion bar 30 and a resultant maintenance of the chassis in a level condition. The center of mass of the vehicle body or chassis will be above the center of the axles 22 and in a severe left hand turn as illustrated will shift to the right and will also tend to roll clockwise about its center of rotation. The center of rotation most likely will be below the center of mass.

The movement of the vehicle into a left turn as illustrated will result in the body or chassis shifting to the right relative to the wheels and axles of the vehicle thereby imposing a force to the right on pivot link 54 and simultaneously through lower pivoting link connector 56 to connecting link 52, to bellcrank 50, to torsion bar sleeve 42, to torsion bar anchor 32 and torsion bar 30. Simultaneously a force will be imposed to the left by the tie link 72 through bellcrank 70 and on the opposite side it ends the cycle to the pivot link 54. These forces will impose a clockwise rotation or pivoting of the torsion bar anchors 32 about its pivot point thereby imposing a downward force on the right-hand torsion bar 30 and an upward force on the opposite torsion bar 30.

This action will simultaneously load the torsional deformation of the torsion bar 30 on the right and unload the torsional deformation of the torsion bar 30 on the left counteracting the tendency of the body of the vehicle to roll to the right. The linkage magnifies the movement of the chassis and transfers that movement to the load connection of the chassis to the support on the torsion bars. In other words the torsional deformation of the torsion bars is magnified when the chassis is in a turn.

FIG. 15 also illustrates the forces acting on the vehicle body as a result of the centrifugal forces from any changing of direction such as going into and through a turn. Centrifugal forces acting on the body to the right as a result of the change in direction will be countered by a ground force to the left acting on the tires at the point of contact with the ground or road surface. This will result in a lifting force on the left side of the body and a down force on the right side of the body tending to roll it about its roll center or axis. These forces are countered by a counter-correcting force of the suspension system with its linkage system thus, maintaining the vehicle chassis and body in a substantially level condition.

In the instant system the link serves to translate a movement of the chassis and the moveable arm of the axles of the suspension system to a vertical force on the down force side of the chassis so that the anti roll linkage simultaneously lifts the down force side of the chassis and lowers the up force side of the chassis.

While certain preferred embodiments have been described above, it is to be understood that a latitude of modification and substitution is intended in the foregoing disclosure, and that these modifications are within the literal scope, or are equivalent to the claims that follow.

Accordingly, it is appropriate that the following claims be construed broadly and in a manner consistent with the spirit and scope of the invention herein described.

I claim:

1. An anti-roll suspension system for a vehicle chassis having at least two laterally spaced front wheels, the suspension comprising:
an axle assembly for mounting each of a pair of laterally spaced wheels;
a torsion bar spring assembly for mounting the chassis on each of the axle assemblies;
an axle assembly at its top end attached pivotally to the outer end of a top control arm and at its lower end attached pivotally to the lower end of a substantially vertical moveable link on each of the axle assemblies;
said vertical moveable link pivotally attached at its top end to the outer end of a lower control arm and attached at its lower end to a moveable lower connecting member on each of the axle assemblies,
said moveable lower connecting member attached at its inner end to the low end of a front lever of a rotatable torsion bar anchor arm on each of the axle assemblies;
said rotatable torsion bar anchor arm linked rigidly to another rotatable torsion bar anchor arm of one side of the vehicle chassis;
and an adjustable tie link connected laterally between said rotatable torsion bar anchor arms defining an anti-roll linkage structured to translate a lateral force on the chassis during a turn to a downward and lateral counter movement of said chassis toward the up force side (inside of the turn) of the chassis and a vertical upward movement on the down force side (inside of the turn) of the chassis so that the anti-roll linkage simultaneously lifts the down force side of the chassis and lowers the up force side of the chassis to thereby counteract roll of the chassis.

2. An anti-roll suspension according to claim 1 wherein a damper is pivotally attached at its lower end to said vertical moveable link and its top is pivotally attached to the top end of said front lever of a rotatable torsion bar anchor arm on each of the axle assemblies.
